(19) United States
(12) Patent Application Publication
(10) Pub. No.: US 2007/0161427 A1
(43) Pub. Date: Jul. 12, 2007

(54) Flexible drive shaft

(76) Inventor: Patrick M. White, West Chester, PA (US)

Correspondence Address: Patrick M. White, 511 Price Street, West Chester, PA, 19382, US

(21) Appl. No.: 11/329,272

(22) Filed: Jan. 10, 2006

(51) Int. Cl. F16C 1/00

(52) U.S. Cl. 464/52

(57) ABSTRACT

A flexible drive shaft is described for transmitting torque off axis. The shaft is selected from an alloy of nickel and titanium to exhibit inelastic characteristics at the operating temperature and further capable of continuous plastic ductile deformation. The ductile nature of the shaft allows it to transmit torque from a drive end to a driven end in off axis applications. In one preferred embodiment the shaft is incorporated into a flexible drill assembly that can be used to drill holes off axis. The assembly has a male quick coupling injection molded onto one end of the drive shaft for attachment to a power source such as a power drill. The opposite end of the shaft has a drill bit attached to the shaft connected by crimping the coupling. In other embodiments fastener drivers, planers, reamers and curettes are shown. Other preferred assemblies containing ductile nickel titanium shafts are also described.

### BACKGROUND OF THE INVENTION

1. Technical Field of the Invention

The present invention relates to flexible shafts useful in the transmission of force. These flexible shafts can be used to transmit torque in tools such as drills, reamers or screw drivers. They can also be used for off axis transmission of force to tools such as chisels or punches.

2. Description of the Related Art

Flexible transmission shafts have been developed for a variety of commercial, medical, industrial and aerospace applications. Their purpose is most commonly to transmit torque or force in an off axis application. They have a driven end which in some cases can hold a tool or can be adapted to activate another component and on the opposing end are adapted to be connected to a power source or to be driven by hand. Generally they are made up of complex assemblies or windings used to achieve the desired result and as such can pose issues for cleaning in the case of medical applications where they may come into contact with blood. In some cases the existing shafts are too stiff to allow a tight bend radius while still maintaining their fatigue resistance under high load. Due to their flexible nature the shafts are most often housed or held in constraint by an outer sleeve, a guide or bearings allowing them to transmit torque while applying axial force. In some instances when used in conjunction with a cutting tool the object being machined will act as the constraining mechanism.

One popular means of flexible power transmission is a wire wound coil shaft. Typically these types of shafts are made of several opposing windings taking on the form of a shaft that is then either welded brazed or swaged onto a tool. U.S. Pat. No. 6,010,407 shows a typical shaft design with multiple apposing windings at FIG. 8. The '407 patent also shows a flexible shaft liner made from a rubber material for dampening the vibrations of the turning shaft and keeping it centered in an external tube. There are numerous shaft designs of the coiled variety using either braided wire, cable or even coiled strip. Due to the windings however, it can be extremely difficult to clean properly after being exposed to chemicals or blood. These agents get trapped inside the windings and in the case of medical devices this can pose issues if any of these substances leached out during surgery. Also, if coil wound springs are not completely housed, axial force applied to a rotating shaft can cause the spring to wrap itself up torsoionally destroying it. This is particularly prevalent in applications where a smaller diameter shaft is being used. Finally, multiple windings can not be driven with the same torque in forward and reverse due to the nature of the windings which limit it's application to efficient bidirectional use.

U.S. Pat. No. 5,769,618 shows another flexible transmission device manufactured from a PEEK plastic material. Shafts manufactured with plastic can be ideal for small deflections, however if the torque needs to be driven off axis by more than a few degrees these shafts break. Plastics of a more flexible nature can be used to increase the bend radius. However their torsional carrying capabilities diminish. Flexible plastics or rubber can be used to transmit loads when reinforced with metallic windings but are not capable of carrying high torsional or axial loads.

U.S. Pat. No. 4,669,172 and U.S. Pat. No. 6,447,518 show examples of using a solid tube with a groove cut into it for providing flexibility. The groove is placed in a helical pattern while others have arranged the groove similar to a thread as shown in U.S. Pat. No. 6,416,517. In either case cutting into the shaft creates stress risers in the material which over time cause fatigue failure especially when subjected to torsional loading.

U.S. Pat. No. 4,706,659 and U.S. Pat. No. 5,797,918 show shafts manufactured as an assembly of inner connecting links. The '659 patent shows a series of dovetail type connecting links. The links are difficult to clean and only allow slight radius of curvature for transmission of torque. The '918 patent shows a hexilobular inner connect which allows for a slightly tighter radius of curvature but still are still difficult to clean. Others have used universal joints to achieve off axis power transmission but are still limited to less than 45 degrees of angulation. U.S. Pat. No. 6,186,900 shows another example of inner connecting links that resemble chain links. Due to the nature of these types of links it is difficult to transfer axial force on the linkage.

U.S. Pat. No. 5,499,984 shows a flexible, hollow tubular drive shaft manufactured from a super-elastic nickel titanium alloy. Due to the limitations of the elastic nature of this alloy achieving a tight bend radius is impossible without causing premature fatigue or shattering of the shaft.

Accordingly there exists a need for a flexible power transmission shaft that is easily cleanable while able to handle transmitting axial and torsional forces to the driven end.

There is another need for a flexible transmission shaft that has a small cross sectional area and free of stress risers while allowing torsional and axial forces to be applied without the shaft wrapping on itself.

There is still yet another need for a flexible drive shaft that can transmit force and torque through a tight radius of curvature.

There is yet another need for a flexible drive shaft that can transmit torque equally in both forward and reverse directions.

There is yet still another need for a flexible drive shaft that can transmit force and torque through high angulation on the driven end without collapsing.

### SUMMARY OF THE INVENTION AND ADVANTAGES

According to one embodiment of the present invention, there is provided a drive shaft assembly for transmitting force. An elongated shaft carries a power source adapter for transmitting force to the assembly while the other end is adapted to carry a tool. The shaft is manufactured from an alloy of nickel titanium which exhibits inelastic characteristics at the operating temperature and further capable of continuous plastic deformation. The assembly is capable of transmitting torsional force from a power source through an adapter to the shaft driving the tool on the other end while the power source and the tool are in an offset relationship.

In yet another embodiment a drive shaft assembly is provided for transmitting torque. The assembly is constructed with a male quick coupling having a drive axis and is adapted to mate with a rotary power source. On the opposite end of the assembly there is a cutting tool with a driven axis. In between an elongated shaft of the present invention is connected to the quick coupling and the tool. The shaft is selected from an alloy of nickel and titanium to exhibit inelastic characteristics at the operating temperature and further capable of continuous plastic deformation. The continuous plastic deformation allows the transmission of torsional force from the rotary power source to the cutting tool while the axes are held in an offset relationship.

In yet still another embodiment of a flexible drive shaft assembly for transmitting torque is disclosed. The assembly has a handle with a drive axis, a fastener drive tool bit with a driven axis and an elongated shaft with one end connected to the handle and the other end operatively connected to the fastener driving tool bit. The shaft is manufactured from an alloy of nickel and titanium which exhibits inelastic characteristics at the operating temperature and further capable of continuous plastic deformation. The continuous plastic deformation allows the transmission of torsional force from the handle to a fastener while the handle and the tool bit are in an offset relationship.

In still yet another embodiment a flexible drive shaft has a first drive end with a an axis and a driven end with another axis. The shaft is selected from an alloy of nickel and titanium to exhibit inelastic characteristics at the operating temperature and capable of continuous plastic ductile deformation. The ductile nature of the shaft allows it to transmit torque from the drive end to the driven end when the axes are offset from each other.

As an advantage of the present invention provided is a flexible transmission shaft which can be small in cross section and free of stress risers which allows torsional and axial forces to be applied without the shaft wrapping on itself.

Another advantage of the invention is to provide a flexible power transmission shaft that is easily cleanable while still being able to handle transmitting axial and torsional forces to the driven end while it is offset from the power source.

In still another advantage is to provide a flexible drive shaft that can transmit force and torque through a tight radius of curvature.

In still yet another advantage is to provide a uniform flexible drive shaft that can transmit torque equally in both forward and reverse directions.

Another advantage of the invention is to provide a flexible drive shaft that can transmit force and torque through high angulation on the driven end without collapsing.

Other objects and advantages will become apparent to a reader skilled in the art, with reference to the following Figures and accompanying Detailed Description wherein textual reference characters correspond to those denoted on the Drawings.

### BRIEF DESCRIPTION OF THE DRAWINGS

In the accompanying drawings:

FIG. 1 is a perspective view of a flexible inelastic drill assembly, according to the present invention;

FIG. 2 is a perspective view of an inelastic drill assembly in a flexed position for use;

FIG. 3 is an enlarged cross sectional view taken longitudinally along Lines 3-3 of FIG. 1;

FIG. 4 is a side view of a flexible inelastic planar assembly, according to the present invention;

FIG. 5 is an end view of the planar assembly shown in FIG. 4;

FIG. 6 is a perspective view of a flexible inelastic planar assembly;

FIG. 7 is a side view of a cannulated modular flexible inelastic reamer shaft assembly, according to the present invention;

FIG. 8 is a side view of a modular cutting head;

FIG. 9 is an enlarged cross sectional view taken longitudinally along Lines 9-9 of FIG. 7;

FIG. 10 is a perspective view of a cannulated modular flexible inelastic reamer shaft assembly with cutting head;

FIG. 11 is a side view of a flexible inelastic screw driver assembly, according to the present invention;

FIG. 12 is a perspective view of an inelastic screw driver assembly shown flexed and engaged with a fastener;

FIG. 13 is a front view of a flexible inelastic curette assembly, according to the present invention;

FIG. 14 is a side view of the flexible inelastic curette assembly of FIG. 13;

FIG. 15 is a side view of an inelastic curette assembly in a flexed position for use;

### DETAILED DESCRIPTION OF THE INVENTION

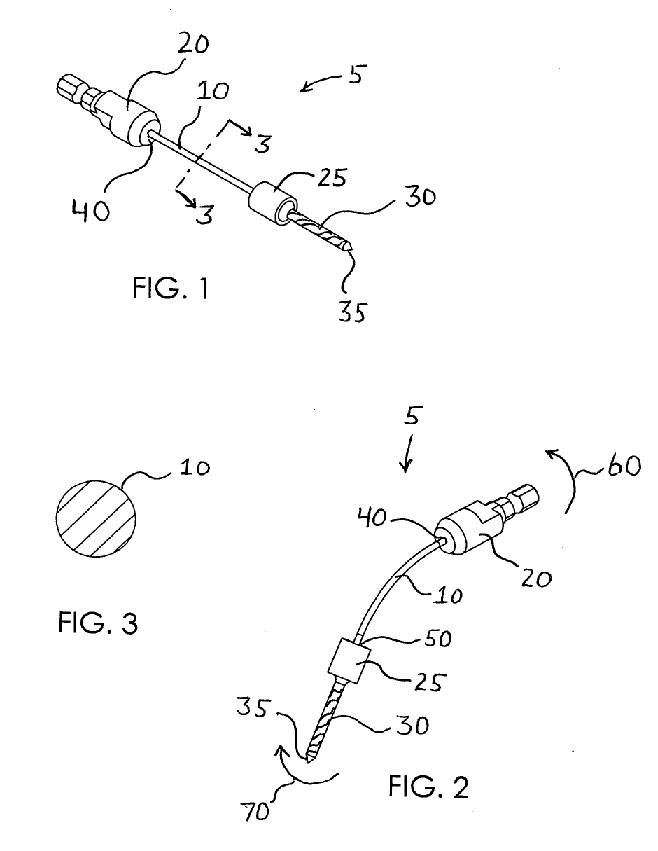

With reference generally to FIGS. 1-15, the Applicant's invention provides assemblies for flexibly transmitting torque.

Referring to FIGS. 1-3 a flexible drill assembly 5 is generally shown. The assembly 5 is manufactured to have a drive coupling 20 and in this case is shown as a male quick connect adapter used to mate with a female quick coupling (not shown) on a power source, however any adapter can be utilized which connects power to the assembly 5, even a handle to apply manual force or a round cylinder which can be attached to a three or four jaw chuck of an electric drill will work and in any case the form of the coupling 20 should not be limiting. The shaft 10 is shown in the form of a wire, however it is important to realize that the form of the shaft is not as important to all the embodiments shown in FIGS. 1-15 as its' mechanical characteristics and could be made in the shape of a rod, tube, cable, band or plate. It is preferable for cleaning that the shaft have a uniform shape and remain solid in cross section as shown in FIG. 3 to avoid creating notch sensitivity. Preferably the shaft 10 should be made from a material that can withstand repeated cyclical loading without failing and should have a ductile nature while at the operating temperature. For instance if the drill assembly 5 is to be used in a warm climate where temperatures are well above 110 degrees Fahrenheit the ductile nature of the material should be manufactured to always exhibit these characteristics above that temperature. Nickel and Titanium or Nickel Titanium as it is referred to can be alloyed to result in a material property that has this ductility and can also be classified as having an in-elastic behavior with continuous plastic deformation. Nickel Titanium is known to be manufactured in two general categories. The first is super-elastic; these alloys have an elastic behavior but for applications requiring high degrees of flexion and tightly radius bends, shafts made from this alloy have a difficult time transmitting the torque while holding the tight radius in a bent configuration. The elastic forces in the shaft cause higher internal stresses leading to lower fatigue resistance during use and early failure results. The second category of Nickel Titanium is classified as having a shape memory characteristic. The temperature at which the material will exhibit the memory characteristics is set during the manufacturing process and this temperature is often referred to as the transition temperature at which a phase transformation between martensite and austenite occur. For this application it is desirable to set the transition temperature above the operating temperature and use the alloy in this form. It is known for these nickel titanium alloys that the higher the transition temperature of the material the higher the fatigue resistance hence their excellent application as a drive shaft. So, below the transition temperature the shaft 10 can be bent with restraint and takes on a ductile nature however it allows the shaft to be reshaped on a continuous basis without fatiguing allowing it to act as a flexible drive. The shaft 10 and the drive coupling 20 are joined at a connection location 40 which can be done in a variety of different ways. The coupling 20 can be injection molded around the shaft 10 to create an intimate bond or they can be crimped, glued, pined, brazed or joined by induction heating. The coupling location 40 can be protected from bending forces by an encasement (not shown) to protect the joint during use. However, the mechanism of attachment is not limiting and any method of joining two pieces of material together should be seen as equivalent. At the opposite end of the drive shaft 10 a drill bit 30 can be found attached to the shaft at another coupling location 50. The drill bit 30 has a coupling section 25 useful for attachment to the shaft 10 and has cutting edges 35. When an input torque 60 is applied to the assembly 5 as shown in FIG. 2 the drill bit 30 can be driven in rotation 70 off axis to cut.

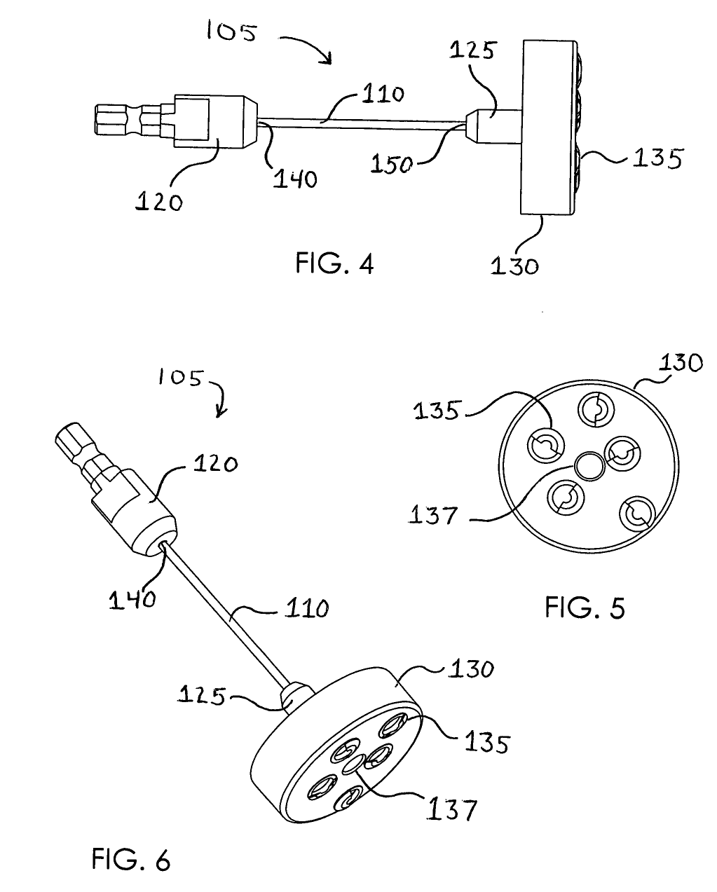

Referring now to FIGS. 4-6 a flexible planar assembly 105 is generally shown. Similar to the flexible drill assembly 5 shown in FIGS. 1-3 the planar 105 has a male quick connect drive coupling 120 attached to a flexible shaft 110 shown in the form of a wire. As previously discussed the shaft 110 is manufactured from a nickel and titanium alloy which exhibits inelastic characteristics at the operating temperature and further capable of continuous plastic deformation. The continuous deformation allows the transmission of torsional force from the drive coupling 120 to the planar 130 while the coupling and the planar are in an offset relationship. The planar 130 has a coupling 125 for attachment to the shaft 110 at coupling location 150 and at the opposite end a shaft coupling 120 is attached at coupling location 140. The couplings 120, 125 can be injection molded around the shaft 110 to create an intimate bond or they can be crimped, glued, pined, brazed or joined by induction heating. The coupling locations 140 and 150 can be protected from bending forces by an encasement (not shown) to protect the joints during use. However, the mechanism of attachment is not limiting and any method of joining two pieces of material together should be seen as equivalent. The planar 130 has cutting teeth 135 and a centralizing bore 137 for aligning the planar to a guide post (not shown). The planar 130 is in the form of hollow body with cutting teeth 135 that are capable of moving material through the planar body during use. Although this planar 130 is in the form of a cylinder it could also be manufactured in the shape of a conical or spherical hollow reamer body as used in orthopedic applications for removing bone in the socket of a hip or shoulder. The planar body 130 is shown manufactured as a plastic injection molded hollow body with metallic cutting teeth 135 permanently fixed to the planar. Alternatively the planar 130 could be manufactured completely from metal with the teeth 135 formed similar to the teeth on a cheese grater.

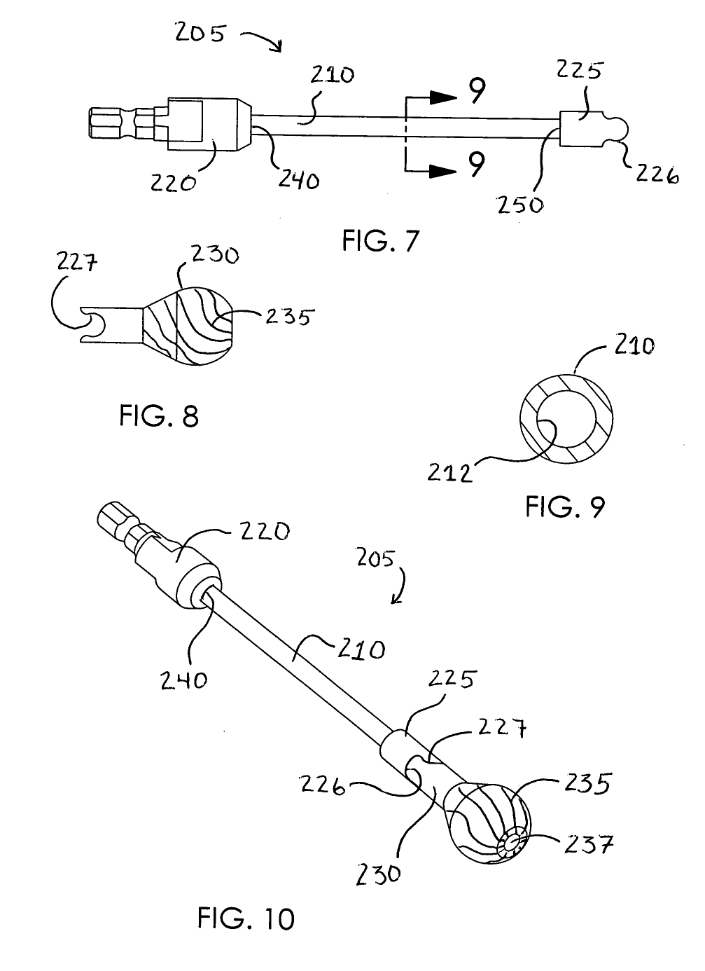

FIGS. 7-10 generally show a cannulated flexible reamer assembly 205. Similar to the flexible drill assembly 5 shown in FIGS. 1-3 the reamer shaft 205 has a male quick connect drive coupling 220 attached to a flexible shaft 210 shown in the form of a tube with a cannulation 212. As previously discussed the shaft 210 is manufactured from a nickel and titanium alloy which exhibits inelastic characteristics at the operating temperature and further capable of continuous plastic deformation. The continuous deformation allows the transmission of torsional force from the drive coupling 220 to a modular reamer head 230 having cutting flutes 235 and cannulation 237 while the coupling and the reamer head are in an offset relationship. While the coupling 220 is shown in the form of a male fitting it could as easily be manufactured as a female coupling and the description should not be seen as limiting. A second quick connect coupling 225 is shown with a male dovetail 226 adapted to receive the female dovetail 227 of the cutting head 230. Dovetails are shown as the modular interface but any mechanism could be used as long as the cutting head 230 can be interchanged with other tools. The flexible reamer assembly 205 has cannulations 212, 237 enabling the assembly to be placed over a guide wire (not shown) for guiding the reamer head 230 while cutting. The couplings 220, 225 are attached to the shaft 210 at coupling locations 240 and 250 respectively. The couplings 220, 225 can be injection molded around the shaft 210 to create an intimate bond or they can be crimped, glued, pined, brazed or joined by induction heating. The coupling locations 240 and 250 can be protected from bending forces by an encasement (not shown) to protect the joints during use. However, the mechanism of attachment is not limiting and any method ofjoining two pieces of material together should be seen as equivalent.

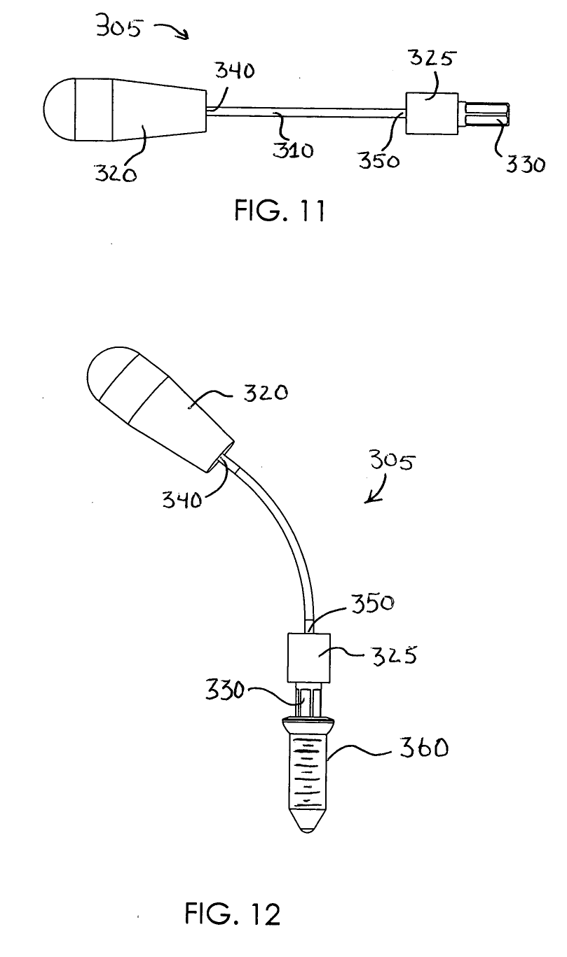

A flexible screwdriver assembly 305 is generally shown in FIGS. 11 and 12. The shaft 310 is shown in the form of a wire and as previously discussed is manufactured from a nickel and titanium alloy which exhibits inelastic characteristics at the operating temperature and further capable of continuous plastic deformation. The continuous deformation allows the transmission of torsional force from a handle 320 attached to the shaft 310 to drive a fastener 360 while in an offset orientation. The torque is transmitted though the shaft 310 to the fastener via a tool bit 325 shown here as a hexagonal drive 330 but could just as easily be a Torx, Philips, Straight, Square, Socket, or any driver bit useful in driving fasteners. The handle 320 and tool bit 325 are attached to the shaft 310 at coupling locations 340 and 350 respectively. The handle 320 can be attached to the shaft 310 by injection molding to create an intimate bond or similar to the tool bit 325 can be attached to the shaft by a crimp, glue, pin, brazing or joined by induction heating. The coupling locations 340 and 350 can be protected from bending forces by an encasement (not shown) to protect the joints during use. However, the mechanism of attachment is not limiting and any method of joining two pieces of material together should be seen as equivalent.

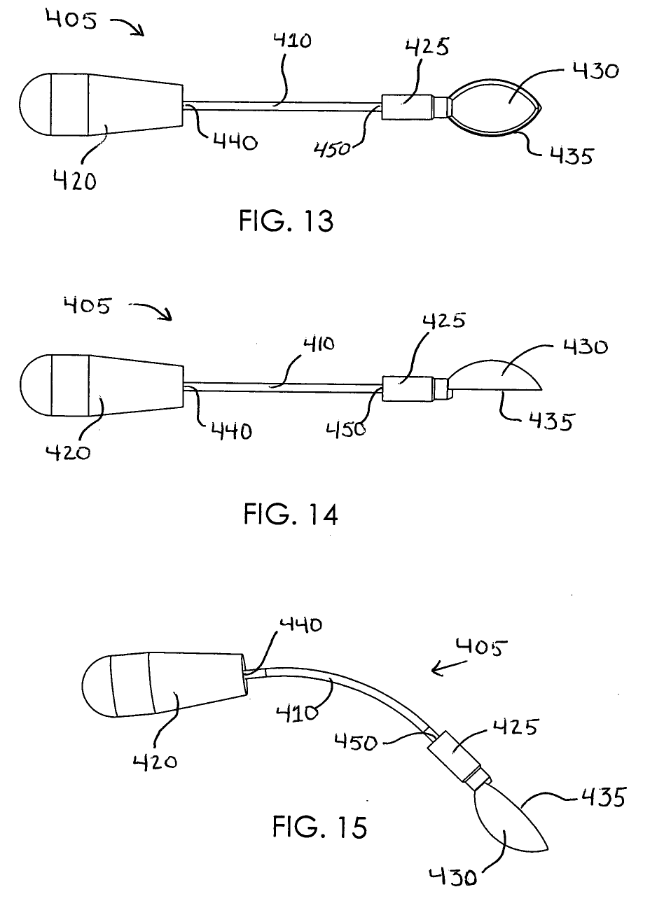

A flexible curett assembly 405 is generally shown in FIGS. 13-15. The shaft 410 is shown in the form of a wire and as previously discussed is manufactured from a nickel and titanium alloy which exhibits inelastic characteristics at the operating temperature and further capable of continuous plastic deformation. The continuous deformation allows the transmission of force from a handle 420 attached to the shaft 410 to the scoop 430 while in an offset orientation. The scoop 430 has a cutting edge 435 and a coupling 425 for attachment to the shaft 410. The handle 420 can be attached to the shaft 410 by injection molding to create an intimate bond or similar to the scoop connection 425 can be attached to the shaft by a crimp, glue, pin, brazing or joined by induction heating. The coupling locations 440 and 450 can be protected from bending forces by an encasement (not shown) to protect the joints during use. However, the mechanism of attachment is not limiting and any method ofjoining two pieces of material together should be seen as equivalent.

The present invention is by no means restricted to the above described preferred embodiments, but covers all variations that might be implemented by using equivalent functional elements or devices that would be apparent to a person skilled in the art, or modifications that fall within the spirit and scope of the appended claims.

What is claimed is:

1. A drive shaft assembly for transmitting force, the assembly comprising:
a power source adapter with a first axis,
a tool with a second axis, and
an elongated shaft having a first end adapted to be driven by a power source and a second end adapted to drive the tool, the shaft being selected from an alloy of nickel and titanium to exhibit inelastic characteristics at the operating temperature and further capable of continuous plastic deformation; wherein
the assembly is capable of transmitting torsional force from the power source through the shaft to the tool while the first axis and second axis are held in an offset relationship.

2. The assembly of claim 1 wherein the continuous plastic deformation in the shaft allows the transmission of force between the first and second ends.

3. The assembly of claim 1 further comprising a quick coupling adapted to receive the power source on the first end.

4. The assembly of claim 1 further comprising a handle adapted to receive the power source on the first end.

5. The assembly of claim 1 further comprising a quick coupling adapted to receive the tool on the second end.

6. The assembly of claim 1 wherein the tool is connected to the shaft.

8. The assembly of claim 1 wherein the tool can be selected from the following group: reamer, planar, curette, drill or screwdriver.

9. A drive shaft assembly for transmitting torque, the assembly comprising:
a male quick coupling having a first axis and adapted to mate with a rotary power source,
a cutting tool with a second axis, and
an elongated shaft having a first end connected with the male quick coupling and a second end operatively connected with the cutting tool, the shaft being selected from an alloy of nickel and titanium to exhibit inelastic characteristics at the operating temperature and further capable of continuous plastic deformation; wherein
the continuous plastic deformation allows the transmission of torsional force from the rotary power source to the cutting tool while the first axis and second axis are held in an offset relationship.

10. The assembly of claim 9 wherein the shaft is cannulated.

11. The assembly of claim 9 wherein the shaft is in the form of a constant diameter wire.

12. The assembly of claim 9 wherein the cutting tool and the male quick coupling are crimped onto the shaft.

13. The assembly of claim 9 wherein the cutting tool can be selected from the following group: reamer, planar or drill.

14. A drive shaft assembly for transmitting torque, the assembly comprising:
a handle with a first axis,
a fastener,
a fastener driving tool bit having a second axis and adapted to drive the fastener, and
an elongated shaft having a first end connected to the handle and a second end operatively connected to the fastener driving tool bit, the shaft being selected from an alloy of nickel and titanium to exhibit inelastic characteristics at the operating temperature and further capable of continuous plastic deformation; wherein
the continuous plastic deformation allows the transmission of torsional force from the handle to the fastener while the first axis and second axis are in an offset relationship.

15. The assembly of claim 14 wherein the shaft is cannulated.

16. The assembly of claim 14 wherein the shaft is in the form of a constant diameter wire.

17. The assembly of claim 14 wherein the fastener driving tool bit and the handle are crimped onto the shaft.

18. The assembly of claim 14 wherein the assembly is a screwdriver.

19. An elongated flexible drive shaft having a first drive end with a first axis and a second driven end with a second axis, the shaft being selected from an alloy of nickel and titanium to exhibit inelastic characteristics at the operating temperature and further capable of continuous plastic ductile deformation; wherein
the ductile nature of the shaft allows it to transmit torque from the drive end to the driven end when the first axis is offset from the second axis.
